(19) United States
(12) Patent Application Publication
(10) Pub. No.: US 2025/0089204 A1
(43) Pub. Date: Mar. 13, 2025

(54) THERMAL MANAGEMENT AND MECHANICAL STRUCTURES IN MULTI-ZONE AUDIO AMPLIFIER

(71) Applicant: JUKE AUDIO INC., Manhattan Beach, CA (US)

(72) Inventors: John Bradford Forth, Rio Grande, PR (US); Yutong GU, Los Angeles, CA (US); Bradford Colton Forth, Manhattan Beach, CA (US); Jerry Woods, PITTSBURGH, PA (US)

(21) Appl. No.: 18/829,144

(22) Filed: Sep. 9, 2024

Related U.S. Application Data
(60) Provisional application No. 63/537,159, filed on Sep. 7, 2023.

(51) Int. Cl. H05K 7/20; H03F 3/183

(52) U.S. Cl. CPC H05K 7/20172; H03F 3/183; H05K 7/20209; H03F 2200/03

(57) ABSTRACT

According to an aspect of an embodiment, thermal management system for an audio amplifier system may include a heatsink and an active thermal management system. The heatsink may be coupled to an enclosure housing the audio amplifier system and an amplifier of the audio amplifier system. The heatsink may be configured to passively dissipate heat generated in the amplifier to the enclosure and provide structural support for the enclosure. The active thermal management system may include a temperature sensor configured to generate temperature data, a fan configured to provide air to the audio amplifier system to lower temperature measured using the temperature sensor and an embedded computing device configured to obtain the temperature data from the temperature sensor and control the fan based on the temperature data.

### CROSS-REFERENCE TO RELATED APPLICATIONS

This patent application claims priority to U.S. Provisional Application No. 63/537,159 filed Sep. 7, 2023, which is incorporated herein by reference in its entirety.

### FIELD

The embodiments discussed in the present disclosure are related to thermal management and mechanical structures of multi-zone audio amplifier systems.

### BACKGROUND

A building or home may include multiple zones or rooms that include separate audio output devices such as speakers. An audio amplifier system may be used to output different audio inputs at the different audio output devices. The audio amplifier system may include devices that receive the audio inputs and provide amplification to drive the audio output devices. As a number of the zones increase, multiple amplifiers or devices that provide amplification may be used to provide amplification to the audio output devices. Increased number of the amplifiers may increase an amount of heat that is generated by the audio amplifier system.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a thermal management system for an audio amplifier system may include a heatsink and an active thermal management system. The heatsink may be coupled to an enclosure housing the audio amplifier system and an amplifier of the audio amplifier system. The heatsink may passively dissipate heat generated in the amplifier to the enclosure and provide structural support for the enclosure. The active thermal management system may include a temperature sensor that generates temperature data representative of a temperature within the enclosure or within an amplifier chip within the audio amplifier system. The active thermal management system may also include a fan configured to direct air within the audio amplifier system to lower the temperature of air within the interior volume of the audio amplifier system. The active thermal management system may also include an embedded computing device configured to obtain the temperature data from the temperature sensor and control the fan based on the temperature data.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates a block diagram of an example environment that includes a multi-zone audio amplifier system that includes a thermal management system;

FIG. 2 illustrates a block diagram of an example of the thermal management system of FIG. 1 connected to an example component of the multi-zone audio amplifier system of FIG. 1;

FIG. 3A illustrates an example heatsink that may be implemented in the thermal management system of FIG. 2, in accordance with one or more embodiments of the present disclosure;

FIG. 3B illustrates the example heatsink of FIG. 3A placed on a PCB of the multi-zone audio amplifier system, in accordance with one or more embodiments of the present disclosure;

FIG. 3C illustrates the example PCB of FIG. 3B, in accordance with one or more embodiments of the present disclosure;

FIG. 3D illustrates an example top cover of an enclosure that may be implemented in the thermal management system of FIG. 1;

FIG. 4 illustrates a flow chart of an example method of active thermal management; and

FIG. 5 illustrates a block diagram of an example computing system that may be used with the multi-zone audio amplifier system;
all in accordance with one or more embodiments of the present disclosure.

### DESCRIPTION OF EMBODIMENTS

A multi-zone audio amplifier system may be used to simultaneously provide various audio output to different zones (e.g., areas) of a building or home. The multi-zone audio amplifier system may permit a single instance of audio content to be provided to multiple zones and/or permit different audio outputs to be provided separately to multiple zones concurrently.

Systems exist today that provide audio outputs to numerous zones in buildings or homes. However, these systems consist of devices that receive audio input from a variety of audio sources and provide amplification of the audio outputs to drive audio output devices. For systems in which the audio output devices are wired to a central location, the systems are complex to install and require the connection and/or configuration of a variety of components. Additionally, these wired systems may consume significant amounts of power and generate a lot of heat.

According to one or more embodiments of the present disclosure, a thermal management system of an audio amplifier system may include a thermal management system that is configured to dissipate the heat generated by the audio amplifier system to reduce a temperature of components of the audio amplifier system. As described in detail in the present disclosure, the thermal management system may include a heatsink that passively dissipates the heat from certain components of the audio amplifier system and also provides structural support for the audio amplifier system. The thermal management system may include an active thermal management system that monitors the temperature of the audio amplifier system and actively dissipates the heat from certain components of the audio amplifier system. Such approaches may allow the temperature of the audio amplifier system to be controlled and help reduce the weight and/or cost of the audio amplifier system.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

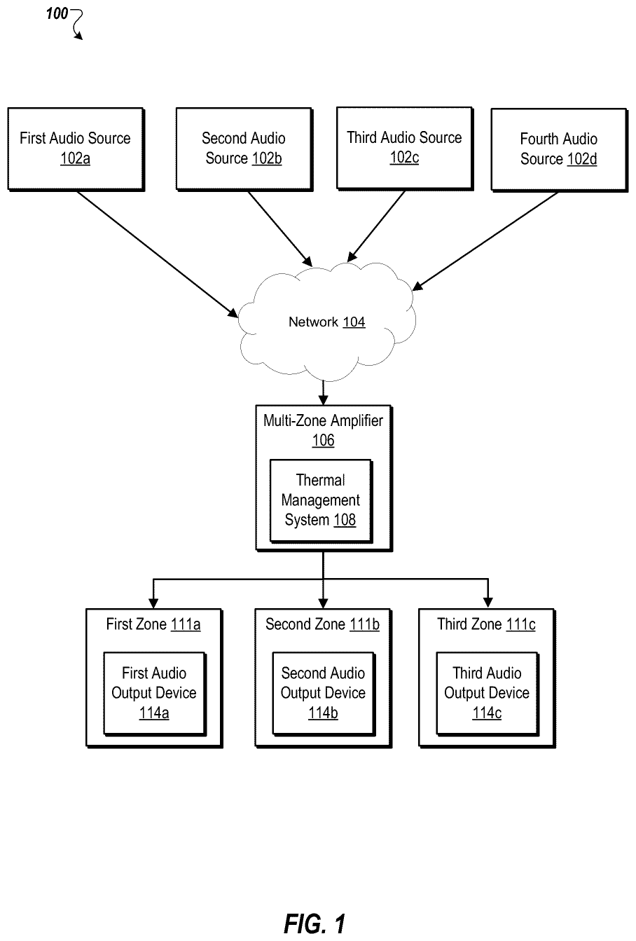

FIG. 1 illustrates an example environment 100 that includes a multi-zone audio amplifier system 106 (“audio amplifier system 106”) that includes a thermal management system 108, in accordance with one or more embodiments of the present disclosure. The audio amplifier system 106 may receive the audio inputs from multiple audio sources. For example, the audio amplifier system 106 may receive the audio inputs from a first audio source 102a, a second audio source 102b, a third audio source 102c, or a fourth audio source 102d (collectively referred to as “audio sources 102”).

The audio sources 102 may include devices that are connected to the audio amplifier system 106 via a network 104. For example, the audio sources 102 may include tablets, computers, smart phones, or any other appropriate wired device or wireless device. Although four audio sources 102 are illustrated, any number of audio sources or devices may be used in association with the audio amplifier system 106. For example, more or fewer audio sources 102 may be used in association with the audio amplifier system 106.

The network 104 may include any suitable type of network such as a local area network (LAN), a wide area network (WAN), a metropolitan area network (MAN), a personal area network (PAN), a campus area network (CAN), a storage area network (SAN), a wireless local area network (WLAN), a cellular network, a satellite network, or any other network which may receive the audio inputs from the audio sources 102 and provide the audio inputs to the audio amplifier system 106. In some embodiments, the network 104 may include a Bluetooth network, Wi-Fi, and Ethernet, although other less common connection methods may also be used.

In some embodiments, the audio inputs may correspond to audio data files representative of songs stored in a digital format, audio recordings created or stored by the audio sources 102, among others. Additionally or alternatively, the audio inputs may represent any audio streaming at the audio sources 102, such as YouTube videos and other multimedia contents from the Internet. The audio sources 102 may receive the audio inputs via online sources or platforms such as Apple Music, Spotify, or any other audio stream providing services or applications that may be operating on the audio sources 102. The audio sources 102 may provide the audio inputs to the audio amplifier system 106 via the network 104.

The audio amplifier system 106 may route the audio inputs to the different zones 111a-c. For example, the audio amplifier system 106 may route the audio inputs to a first zone 111a, a second zone 111b, or a third zone 111c (collectively referred to as “zones 111”). Although three zones 111 are illustrated, the audio amplifier system 106 may be associated with any suitable number of zones. In the present disclosure, the zones 111 may include physical locations, such as different rooms in a building or a home, different buildings, or any other appropriate physical location. Each of the zones 111 may include audio output devices 114a-c. For example, the first zone 111a may include a first audio output device 114a, the second zone 111b may include a second audio output device 114b, and the third zone 111c may include a third audio output device 114c. Examples of the audio output devices 114a-c include speakers, or any appropriate device configured to play sounds based on the audio inputs. In some embodiments, each audio output device of the audio output devices 114 may include multiple audio output devices. For example, the first audio output device 114a may include a left audio output device corresponding to a left channel of the first zone 111a and a right audio output device corresponding to a right channel of the first zone 111a.

The audio amplifier system 106 may route the audio inputs from the audio sources 102 to the zones 111 in various manners. For example, the audio amplifier system 106 may route the audio inputs so that each of the zones 111 receives a different audio input. In another example, the audio amplifier system 106 may route the audio inputs so that at least two of the zones 111 receive the same audio input.

In some embodiments, various components of the audio amplifier system 106, such as amplifiers and capacitors, generate heat which, if not managed, may damage the audio amplifier system 106. In these and other embodiments, the audio amplifier system 106 may include a thermal management system 108 configured to manage the heat generated by the components of the audio amplifier system 106. The thermal management system 108 may monitor and control a temperature inside an enclosure of the audio amplifier system 106 or a temperature of the components of the audio amplifier system 106, such that overheating or thermal shutdown of the components and/or the audio amplifier system 106 may be reduced.

Modifications, additions, or omissions may be made to the environment 100 without departing from the scope of the present disclosure. For example, in some embodiments, the environment 100 may include any number of other components that may not be explicitly illustrated or described.

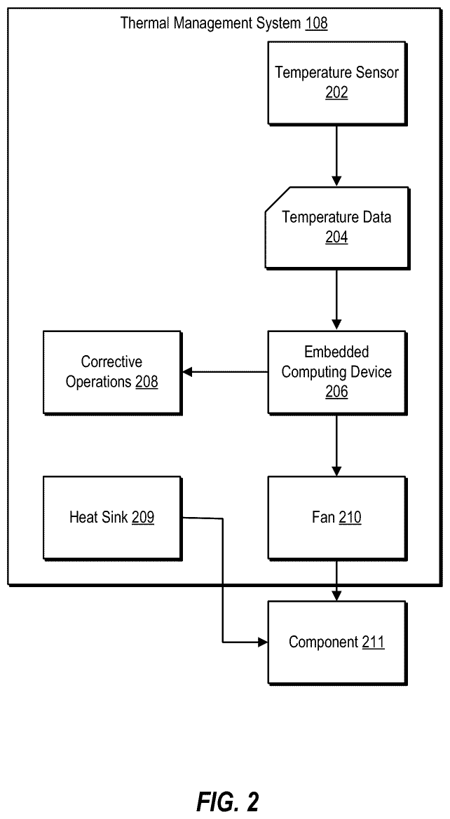

FIG. 2 illustrates a block diagram of an example of the thermal management system 108 of FIG. 1 connected to an example component 211 of the audio amplifier system 106 of FIG. 1, in accordance with one or more embodiments of the present disclosure. In some embodiments, the thermal management system 108 may include a temperature sensor 202, an embedded computing device 206, a heatsink 209, and/or a fan 210. In these and other embodiments, the temperature sensor 202, the embedded computing device 206, or the fan 210 may form an active thermal management system.

In some embodiments, the temperature sensor 202 may include multiple sensors configured to generate temperature data 204 representative of the temperature of the component 211 or the temperature of the interior volume of the enclosure of the audio amplifier system 106. For example, the temperature sensor 202 may include thermal diodes, thermocouples, resistance temperature detectors (RTDs), thermistors, semiconductor temperature sensors, infrared sensors, among others. The temperature sensor 202 may generate the temperature data 204 in formats that are compatible with the embedded computing device 206. For example, the temperature data 204 may include data in a raw sensor output format, a hexadecimal format, a binary format, a sensor-specific format, among others.

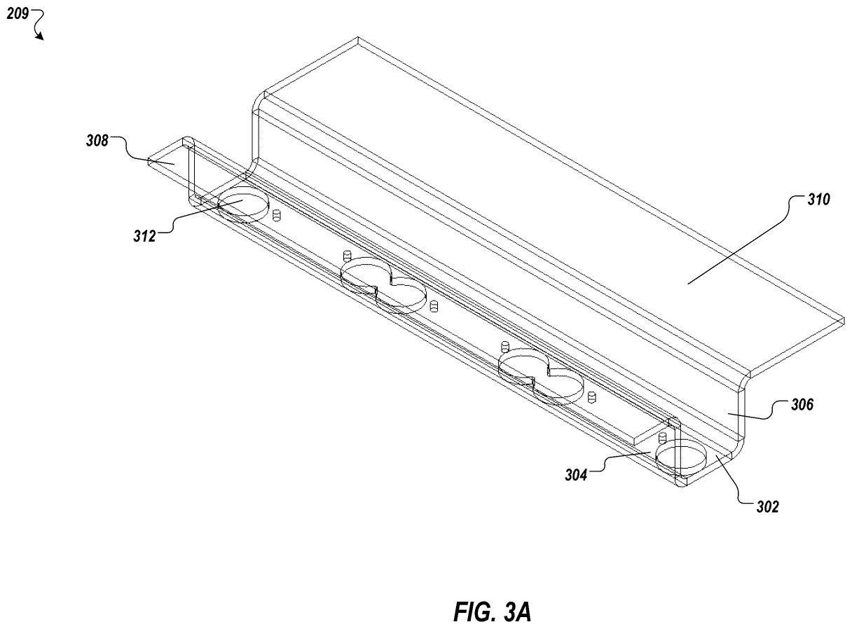

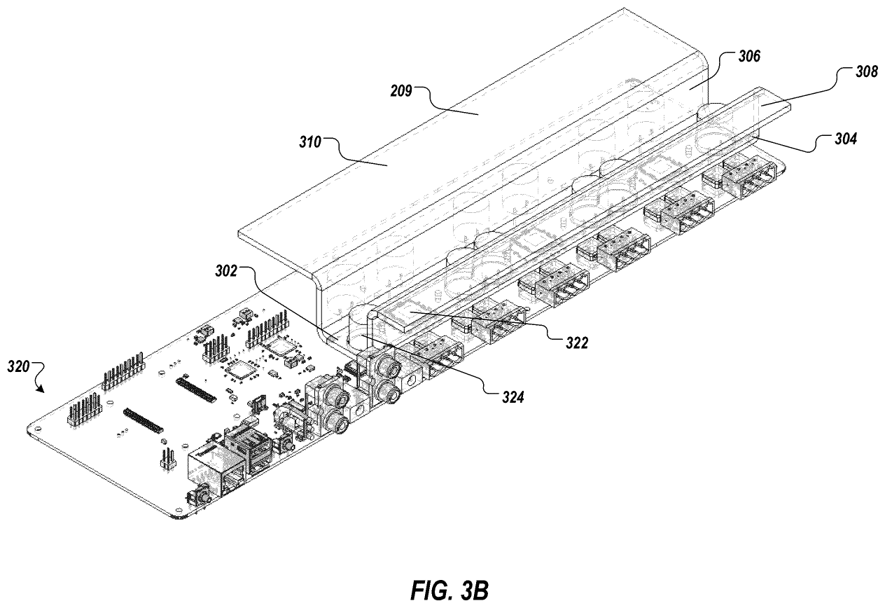

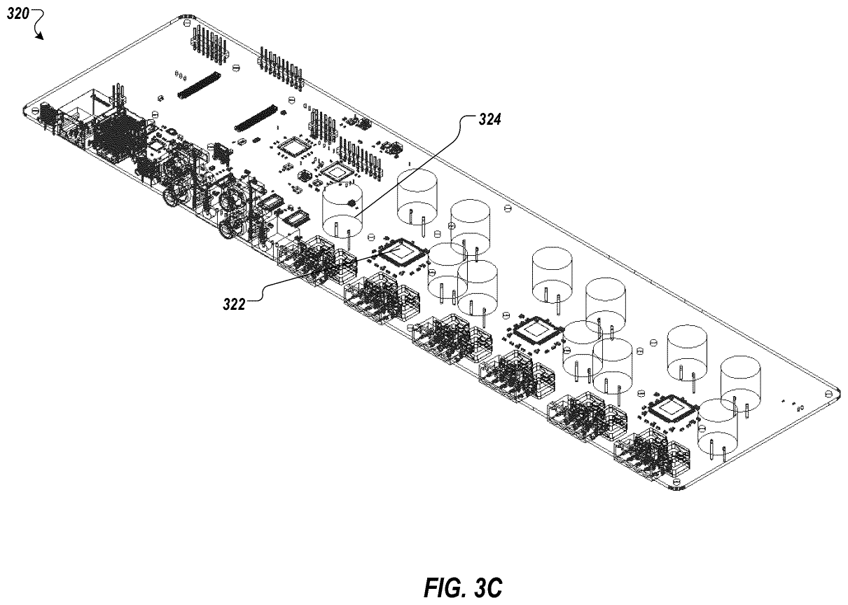

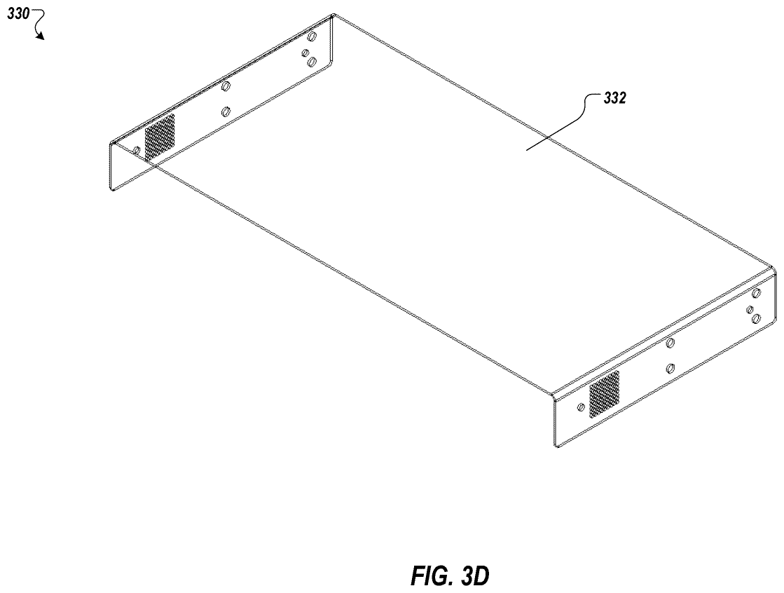

In some embodiments, the temperature sensor 202 may be placed and/or configured such that each sensor generates corresponding portions of the temperature data 204 relative to different locations or components of the audio amplifier system 106. For example, the audio amplifier system 106 may include a printed circuit board (PCB) (such as denoted 320 in FIG. 3C) that includes at least a portion of the various components of the audio amplifier system 106 (e.g., component 211). In such instances, the sensors of the temperature sensor 202 may be placed and/or configured to generate the temperature data 204 relative to different locations of the PCB.

In some embodiments, the locations and/or configurations of the sensors of the temperature sensor 202 may be based on locations of the components of the audio amplifier system 106 (e.g., component 211). For example, the sensors of the temperature sensor 202 may be located to measure temperature of and/or around particular certain components to ensure the temperatures of the particular components are managed. For example, one sensor of the temperature sensor 202 may be located proximate or on an amplifier (e.g., an amplifier chip on the PCB) to measure the temperature of the amplifier (e.g., the component 211).

The embedded computing device 206 may obtain the temperature data 204 from the temperature sensor 202. The embedded computing device 206 may analyze the temperature data 204 to determine corrective operations 208 for the thermal management system 108 or another component of the audio amplifier system 106. In some embodiments, the embedded computing device 206 may determine the corrective operations 208 for the active thermal management system to perform.

The embedded computing device 206 may compare the temperatures indicated in the temperature data 204 to corresponding temperature thresholds to determine whether active management of the temperatures is to be performed. For instance, the temperature thresholds may represent a temperature that may be undesirable or at which operation of the component 211 may become compromised. The measured temperatures being equal or exceeding the temperature threshold may indicate that the corrective operations 208 are to be performed.

The temperature thresholds may vary for one or more components of the audio amplifier system 106 and accordingly the embedded computing device 206 may compare two or more of the temperatures to different temperature thresholds. For example, the embedded computing device 206 may compare the temperature of the component 211 to a first temperature threshold and the temperature of the interior volume of the enclosure to a second temperature threshold. In some embodiments, the different temperature thresholds may be based on operational parameters of the different components associated with the different sensors of the temperature sensor 202 due to the components having different susceptibilities to heat. For example, the component 211 may suffer from overheating at a lower temperature compared to another component.

In some embodiments, the corrective operations 208 may cause a power usage of certain components of the audio amplifier system 106 to be reduced (e.g., turning down the volume level to reduce an amplification level of an amplifier, or turning off certain zones of certain amplifiers of the audio amplifier system). Additionally or alternatively, the corrective operations 208 may cause the embedded computing device 206 to turn the fan 210 on to dissipate heat from the component 211 and/or the interior volume of the enclosure of the audio amplifier system 106 (e.g., move air within the interior volume of the enclosure to move the heat to edges of the enclosure). Additionally or alternatively, the fan 210 may expel the air from the interior volume of the enclosure through ventilation holes defined by the enclosure. In some embodiments, the embedded computing device 206 may determine a velocity of the fan 210 based on the temperature data 204. For example, in response to one or more corresponding temperatures represented in the temperature data 204 exceeding the corresponding temperature thresholds, the embedded computing device 206 may determine the velocity of the fan 210 is to be increased. In some embodiments, the fan 210 may include multiple instances of fans. In some embodiments, the multiple instances of the fans may be placed such that the multiple instances of the fans correspond to temperatures measured at the different locations. In some embodiments, at least one fan 210 may be configured to pull air from the exterior of the enclosure (e.g., the environment) to the interior of the enclosure. For example, the fan 210 may be configured to pull air into the enclosure along an edge of the enclosure, such that the cooler air from the environment may pass over the heated components of the PCB. In some embodiments, the air may be expelled out of the enclosure through the opposite side the air came in, after passing over the components.

In some embodiments, one or more sensors of the temperature sensor 202 may be integrated as part of the component 211. For example, the one or more sensors of the temperature sensor 202 may be integrated as part of an amplifier of the audio amplifier system 106. Such integrated sensors of the temperature sensor 202 may generate the temperature data 204 specific to the component (e.g., the amplifier) in which the device is integrated. For example, the amplifiers may include specific designs and/or models that include integrated temperature sensors 202. For example, the amplifiers may include Texas Instruments TAS6584 or any other suitable models with integrated temperature sensors 202. In these and other embodiments, one of the temperature sensors 202 may be located between the amplifiers and the embedded computing device 206 or another circuitry.

With combined reference to FIGS. 2-3C, the heatsink 209 may be connected to the component 211. Additionally or alternatively, the heatsink 209 may be positioned on or proximate a top portion of a PCB 320 (shown in FIG. 3C) that includes different components. In some embodiments, when positioned on the top portion of the PCB 320, a base 302 of the heatsink 209 may contact portions of certain components of the PCB 320. In some embodiments, the heatsink 209 may contact the components of the PCB 320 that generate the most heat and/or are most susceptible to heat. For example, the PCB 320 may include one or more amplifiers 322 that generate significant amounts of heat when providing increased outputs. In such instances, the heatsink 209 may be placed such that the base 302 contacts the amplifiers 322.

In some embodiments, the PCB 320 may include certain components positioned proximate the amplifiers 322 that extend further from the PCB 320 than the amplifiers 322. For example, the PCB 320 may include capacitors 324, which as shown in FIG. 3B, are positioned proximate the amplifiers 322 and extend further from the PCB 320 than the amplifiers 322. In such instances, the base 302 may define one or more cutouts 312 configured to receive the corresponding components (e.g., the capacitors 324) to permit the base 302 to contact the amplifiers 322.

As shown in FIG. 3A, the heatsink 209 may include a first wall 304 and a second wall 306 that extend from the base 302. In some embodiments, the first wall 304 and the second wall 306 may be taller in height than the components of the PCB 320, such as the capacitors 324. The heatsink 209 may further include a first flange 308 that, when the heatsink 209 is installed in the audio amplifier system 106, extends from the first wall 304 toward a wall of the enclosure (not shown). In addition, the heatsink 209 may include a second flange 310 that, when the heatsink 209 is installed in the audio amplifier system 106, extends from the second wall 306 toward a different wall of the enclosure.

With reference to FIGS. 3C and 3D, the first flange 308 and the second flange 310 may be configured and/or designed to directly contact a top cover 330 (shown in FIG. 3D) of the enclosure The top cover 330 may include a top portion 332 that, when the heatsink 209 is installed in the audio amplifier system 106, contacts surfaces of the first flange 308 or the second flange 310.

Referring to FIGS. 2-3D, the heatsink 209 may passively dissipate the heat generated by the component 211 (e.g., the amplifiers 322). For example, the heat generated by the amplifiers 322 may transfer to the heatsink 209 via the base 302 and conduction heating. The heatsink 209 may dissipate the heat by transferring the heat from the base 302 to the first flange 308 and the second flange 310 through the first wall 304 and the second wall 306, respectively. The heatsink 209 may further dissipate the heat by transferring the heat from the first flange 308 and the second flange 310 to the top portion 332 of the top cover 330. In these and other embodiments, the top cover 330 may dissipate the heat to the environment, thereby removing the heat generated by the amplifiers 322 into the environment. In some embodiments, the enclosure and/or the top cover 330 may be built using a thermally conductive material to facilitate heat transfer. For example, the enclosure may be built using a metal, such as aluminum.

In some embodiments, the heatsink 209 may provide structural support for the enclosure. For example, the first flange 308 and the second flange 310, when the heatsink 209 is installed in the audio amplifier system 106, may contact the top portion 332 of the top cover 330 to provide structural support for the top cover 330. For example, the first flange 308 and the second flange 310 may contact the top cover 330 and the first wall 304 and the second wall 306 may support the first flange 308 and the second flange 310 to provide vertical support and support the top cover 330.

In these and other embodiments, the heatsink 209 providing the structural support for the top cover 330 may eliminate a separate support structure being used within the audio amplifier system 106. Such implementations may permit the enclosure to house the PCB 320 without a separate support structure which may reduce a height of the enclosure compared to the audio amplifier system 106 including a heat sink and the separate support structure. Additionally or alternatively, the heatsink 209 may allow the top cover 330 to be made of thinner material (e.g., fabricated using a thinner material) as the heatsink 209 provides structural support for the top cover 330. Such implementations may permit the enclosure to house the PCB 320 to be thinner, therefore reducing the height while using reduced or thinner material. Additionally, the heatsink 209 may permit the base 302 to be thin as the first wall 304 and the second wall 306 are connected to the base 302 along a length of the base 302 to prevent the base 302 from bending.

In some embodiments, the heatsink 209 may be connected (e.g., screwed through the PCB 320) to a bottom cover (not shown) of the enclosure at multiple locations. The bottom cover may be configured to mate with the top cover 330 to enclose or cover the audio amplifier system (e.g., the PCB 320, the heatsink 209, etc.). Such configuration may permit the heatsink 209 to provide support for the bottom cover. For example, the heatsink 209 may provide support for the bottom cover at the multiple locations to help reduce bending or warping of the bottom cover. The heatsink 209 may permit the bottom cover to be manufactured using thinner materials, which may help the enclosure to be reduced in height.

In some embodiments, the heatsink 209 may permit a height of the enclosure to be approximately 1.75 inches, which is 1 U or one rack unit of a typical equipment rack In other embodiments, the height may be less than or equal to 1.75 inches. Such reduced height of the enclosure of the audio amplifier system 106 may reduce material costs and permit the audio amplifier system 106 to fit in smaller spaces. The height of 1.75 inches or less may allow the audio amplifier system 106 to be positioned in a single standard slot of an equipment rack, which are configured to fit equipment with 1 U height. In some embodiments, the height of the audio amplifier system 106 may permit multiple instances of the audio amplifier system 106 to be stacked and reduce space and costs associated with operating the audio amplifier system 106.

Modifications, additions, or omissions may be made to the heatsink 209 without departing from the scope of the present disclosure. For example, in some embodiments, the heatsink 209 may include any number of other components that may not be explicitly illustrated or described.

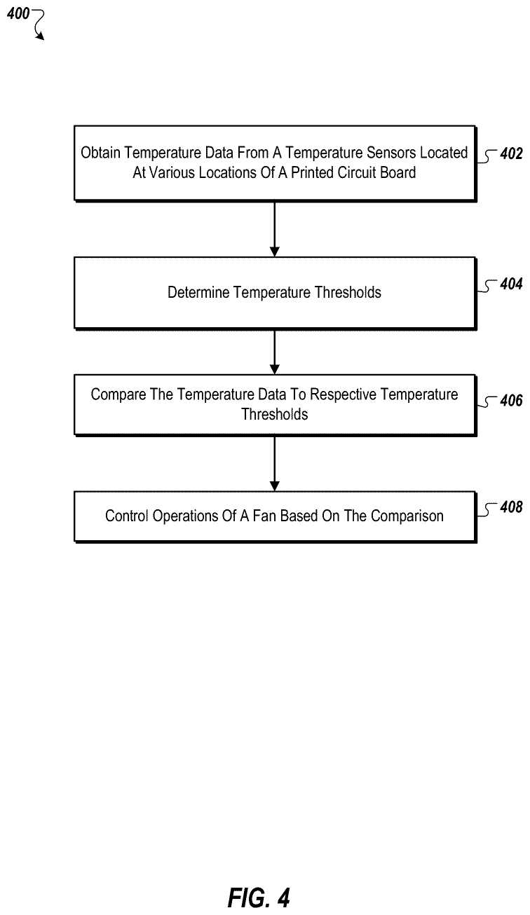

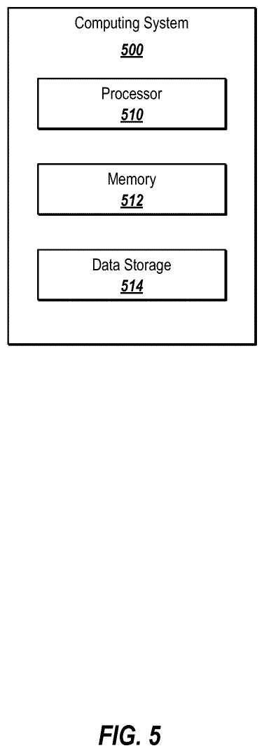

FIG. 4 illustrates a flow chart of an example method 400 of active thermal management, arranged in accordance with at least one embodiment of the present disclosure. One or more operations of the method 400 may be implemented by any suitable element of an active thermal management system such as the thermal management system 108 of FIGS. 1 and 2. Although illustrated as discrete steps, various steps of the method 400 may be divided into additional steps, combined into fewer steps, or eliminated, depending on the desired implementation. Additionally, the order of performance of the different steps may vary depending on the desired implementation. The method 400 may include blocks 402, 404, 406, and 408.

At block 402, temperature data may be obtained from temperature sensors located at various locations of a PCB. In some embodiments, the temperature sensors may correspond to the temperature sensor 202 of FIG. 2. The temperature sensors may be located at the various locations such that temperature data may represent temperatures of and/or near different components placed on the PCB.

At block 404, temperature thresholds may be determined. The temperature thresholds may correspond to the temperature sensors. The temperature thresholds may represent a temperature limit for a corresponding area and/or components associated with the temperature sensors. For example, a particular temperature sensor may be located and/or configured to generate the temperature data for an amplifier on the PCB. The particular temperature sensor may be associated with a particular temperature threshold which may define a temperature limit for the amplifier. The temperature limit may represent a temperature level to be kept at or below for safe operation of various components of the multi-zone audio amplifier system with reduced risk of overheating or thermal failures.

At block 406, the temperature data may be compared to respective temperature thresholds. For example, the temperature levels at various locations may be compared to the respective temperature thresholds to determine whether the temperature levels are at or below the temperature limit or threshold.

At block 408, operations of a fan may be controller based on the comparison. For example, in response to the temperature exceeding the temperature threshold, the embedded computing device may turn on the fan to remove the heat and decrease the temperature. In some embodiments, the embedded computing device may operate or turn the fan on in response to the temperature data exceeding any one temperature threshold of the set of temperature thresholds.

In some embodiments, the multi-zone audio amplifier system may include multiple fans located at various locations. In these and other embodiments, the embedded computing device may operate different fans at different rates based on the temperature thresholds that are exceeded. For example, in response to the temperature data exceeding the temperature threshold associated with the temperature sensor associated with the amplifier, the embedded computing device may operate a fan located near the amplifier to help lower the temperature of the amplifier.

Modifications, additions, or omissions may be made to the method 400 without departing from the scope of the present disclosure. For example, one skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

FIG. 5 illustrates a block diagram of an example computing system 500 that may be used with respect a multi-zone audio amplifier system, according to at least one embodiment of the present disclosure. For example, the computing system 500 may correspond to the embedded computing device of the multi-zone audio amplifier system, such as the embedded computing device 206 of FIG. 2.

The computing system 500 may include a processor 510, a memory 512, and a data storage 514. The processor 510, the memory 512, and the data storage 514 may be communicatively coupled.

In general, the processor 510 may include any suitable special-purpose or general-purpose computer, computing entity, or processing device including various computer hardware or software modules and may be configured to execute instructions stored on any applicable computer-readable storage media. For example, the processor 510 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 5, the processor 510 may include any number of processors configured to, individually or collectively, perform or direct performance of any number of operations described in the present disclosure. Additionally, one or more of the processors may be present on one or more different electronic devices, such as different servers.

In some embodiments, the processor 510 may be configured to interpret and/or execute program instructions and/or process data stored in the memory 512, the data storage 514, or the memory 512 and the data storage 514. In some embodiments, the processor 510 may fetch program instructions from the data storage 514 and load the program instructions in the memory 512. After the program instructions are loaded into memory 512, the processor 510 may execute the program instructions.

The memory 512 and the data storage 514 may include computer-readable storage media for carrying or having computer-executable instructions or data structures stored thereon. Such computer-readable storage media may include any available media that may be accessed by a general-purpose or special-purpose computer, such as the processor 510. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 510 to perform a certain operation or group of operations.

Modifications, additions, or omissions may be made to the computing system 500 without departing from the scope of the present disclosure. For example, in some embodiments, the computing system 500 may include any number of other components that may not be explicitly illustrated or described.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Additionally, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B” even if the term “and/or” is used elsewhere.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A thermal management system for an audio amplifier system comprising:
a heatsink coupled to an enclosure housing the audio amplifier system and an amplifier of the audio amplifier system, the heatsink configured to:
passively dissipate a heat generated in the amplifier to the enclosure; and
provide structural support for the enclosure; and
an active thermal management system comprising:
a temperature sensor configured to generate temperature data;
a fan configured to provide air to the audio amplifier system to lower temperature measured using the temperature sensor; and
an embedded computing device configured to obtain the temperature data from the temperature sensor and control the fan based on the temperature data.

2. The thermal management system of claim 1, wherein the embedded computing device is configured to:
compare the temperature data to a temperature threshold; and
cause the fan to turn on or off based on the comparison.

3. The thermal management system of claim 2, comprising a plurality of temperature sensors comprising the temperature sensor, wherein the plurality of temperature sensors is located at various locations of the audio amplifier system to obtain the temperature data corresponding to the various locations.

4. The thermal management system of claim 3, wherein each temperature sensor of the plurality of temperature sensors is associated with a temperature threshold associated with a corresponding location of the various locations.

5. The thermal management system of claim 4, wherein, responsive to the temperature data being equal to or exceeding the temperature threshold, the embedded computing device is configured to cause the fan to turn on.

6. The thermal management system of claim 1, wherein the temperature sensor is integrated with an amplifier of the audio amplifier system.

7. The thermal management system of claim 1, wherein the fan is configured to remove air from an interior volume of the enclosure to edges of the enclosure.

8. The thermal management system of claim 7, wherein the fan expels the air from the interior volume of the enclosure through ventilation holes defined by the enclosure.

9. The thermal management system of claim 1, wherein the heatsink comprises:
a base configured to contact an amplifier on a printed circuit board of the audio amplifier system;
a wall extending from the base;
a flange extending from the wall.

10. The thermal management system of claim 1, wherein the heatsink comprises:
a base configured to contact an amplifier on a printed circuit board of the audio amplifier system;
a first wall and a second wall extending from the base;
a first flange extending from the first wall toward a first wall of the enclosure; and
a second flange extending from the second wall toward a second wall of the enclosure.

11. The thermal management system of claim 10, wherein the base of the heatsink defines a cutout configured to receive a component on the printed circuit board that is taller than the amplifier on the printed circuit board to permit the base of the heatsink to directly contact the amplifier.

12. The thermal management system of claim 10, wherein:
the first flange and the second flange directly contact a top cover of the enclosure, and
the first flange and the second flange dissipate heat from the heatsink to the top cover of the enclosure.

13. The thermal management system of claim 10, wherein the first flange and the second flange provide structural support for at least one of a top cover or a bottom cover of the enclosure.

14. The thermal management system of claim 13, wherein the heatsink provides the structural support for the enclosure without a separate support structure to reduce a height of the enclosure.

15. The thermal management system of claim 13, wherein the heatsink provides the structural support for the enclosure to permit at least one of the top cover or the bottom cover of the enclosure to be made with thinner material.

16. The thermal management system of claim 14, wherein the height of the enclosure is about 1.75 inches.

17. The thermal management system of claim 14, wherein the height of the enclosure is less than or equal to 1.75 inches.

18. The thermal management system of claim 1, wherein the heat transfers from the amplifier to the heatsink, from the heatsink to the enclosure, and from the enclosure to environment.

19. The thermal management system of claim 1, wherein the enclosure is made of aluminum.

20. The thermal management system of claim 1, wherein the enclosure is made of steel.

21. The thermal management system of claim 1, wherein the amplifier of the audio amplifier system comprises a Texas Instruments TAS6584.

22. A method comprising:
obtaining temperature data from a plurality of temperature sensors located at various locations of a printed circuit board;
determining a plurality of temperature thresholds respectively corresponding to the plurality of temperature sensors;
comparing the temperature data to respective temperature threshold; and
controlling operations of a fan based on the comparison.

23. The method of claim 22, wherein responsive to the temperature data obtained being equal to or exceeding the respective temperature threshold, the fan is turned on.

24. The method of claim 22, wherein a velocity at which the fan is to operate is determined based on the temperature data.

25. The method of claim 22, further comprising:
identifying a particular temperature sensor generating the temperature data being equal to or exceeding the respective temperature threshold; and
reducing volume of a zone associated with the particular temperature sensor.
